(19) United States
(12) Patent Application Publication
(10) Pub. No.: US 2012/0282498 A1
(43) Pub. Date: Nov. 8, 2012

(54) LITHIUM-ION BATTERY

(75) Inventor: Guenter Eichinger, Altenstadt (DE)

(73) Assignee: LI-TEC BATTERY GMBH, Kamenz (DE)

(21) Appl. No.: 13/516,710

(22) PCT Filed: Nov. 22, 2010
(86) PCT No.: PCT/EP10/07063

§ 371 Date: Jul. 25, 2012

(30) Foreign Application Priority Data
Dec. 17, 2009 (DE) 10 2009 058 606.7

(51) Int. Cl. H01M 2/16; H01M 10/04

(52) U.S. Cl. 429/50; 429/144; 29/623.1

(57) ABSTRACT

A lithium-ion battery in a housing includes (a) an anode, (b) a cathode, (c) a separator, (d) an electrolyte including a lithium salt and a non-aqueous solvent, and (e) a non-ionic surfactant.

### CROSS-REFERENCE TO RELATED APPLICATIONS

This application is a national stage application under 35 U.S.C. §371 of International Application No. PCT/EP2010/007063, filed Nov. 22, 2010 and published as WO 2011/072792, which claims priority to German patent application number DE 10 2009 058 607.7, filed Dec. 17, 2009, the entirety of each of which is hereby incorporated herein by reference.

### SUMMARY AND DETAILED DESCRIPTION

The present invention relates to a secondary battery, in particular to a lithium-ion battery having improved properties, such as a reduced capacity loss while formatting, respectively in the charge/discharge operation. The invention also relates to a method of manufacturing the battery as well as the use thereof.

Secondary batteries, in particular lithium-ion secondary batteries, are used because of their high energy density and high capacity as driving power for mobile information devices. Furthermore, such batteries are also used for tools, electrically driven cars and cars having hybrid drive.

Great demands apply in regard to such batteries with respect to capacity and energy density. In accordance with the present invention, it is, among other things, advantageous in order to achieve desired properties, that the pores of the electrodes that are contained in the battery and, in particular, the pores of the separator are filled with electrolyte as homogeneously and as completely as possible. The complete filling of said pores, however, in general, is complex since the electrolyte has to displace the gas, which is contained in the pores.

This is a relatively slow process and also a process that mostly also does not proceed quantitatively. Methods in which the gas is to be removed prior to the filling in vacuum are hard to realize reproducibly.

U.S. Pat. No. 6,960,410 B2 (WO 02/091497 A2) suggests to add a fluorine-containing non-ionic substance to the electrolyte for lithium-ion batteries in order to reduce the impedance between electrolyte and electrode.

The problem to be solved by the present invention is to provide a secondary battery, in particular a lithium-ion secondary battery, in which the pores of the electrodes and the separators are filled with electrolyte, respectively may be filled with electrolyte, in a manner so that the capacity of a battery in the charge/discharge operation is maintained to be as high as possible.

This problem is solved by means of a lithium-ion battery that comprises components (a) to (e):

(a) anode;

(b) cathode;

(c) separator;

(d) electrolyte, which comprises a lithium salt and a non-aqueous solvent;

(e) at least one non-ionic surfactant.

Therein, the separator, preferably, is not or is only poorly electron-conducting, and preferably comprises a carrier that is at least partially permeable in regard to materials, wherein the carrier, preferably, is coated with an inorganic material on at least one side, wherein preferably an organic material is used as the carrier that is at least partially permeable in regard to materials, which, preferably, is formed as a non-woven fabric, wherein the organic material preferably comprises a polymer and, in particular, comprises a polyethylene terephthalate (PET), wherein the organic material is coated with an inorganic material, preferably with an ion-conducting material, which, further preferably, is ion-conducting in a temperature range of from −40° C. to 200° C., wherein the inorganic material preferably comprises a compound from the group of oxides, phosphates, sulfates, titanates, silicates, aluminosilicates of at least one of the elements Zr, Al, Li, particularly preferred zirconium oxide, and wherein the inorganic, ion-conducting material preferably comprises particles having a largest diameter of less than 100 nm.

In the following, the terms “lithium-ion battery” and “lithium-ion secondary battery” are used synonymously. The terms also encompass terms such as “lithium battery”, “lithium-ion accumulator” and “lithium-ion cell”. In general, a lithium-ion accumulator consists of a serial connection, respectively a connection in series, of individual lithium-ion cells. This means that the term “lithium-ion battery” is a collective term for the aforementioned terms, which are commonly used in the prior art.

The term “positive electrode” encompasses the electrode, which, when connecting the battery to a load, such as an electric motor, is capable of accepting electrons. Then, the positive electrode is the cathode. The term “negative electrode” encompasses the electrode, which, during operation, is capable of releasing electrons. Then, the negative electrode is the anode.

The anode (a) of the battery according to the invention may be made from a plurality of materials, which are suitable for the use of a battery comprising a lithium-ion electrolyte. For example, the negative electrode may comprise lithium metal or lithium in the form of an alloy, either in the form of a foil, a grid or in the form of particles, which are kept together by means of a suitable binder. The use of lithium metal oxides such as lithium titanium oxide is likewise possible. Generally, all materials may be used, which are capable of forming intercalation compounds with lithium. Suitable materials for the negative electrode then, for example, comprise graphite, synthetic graphite, soot, mesocarbon, doped carbon, fullerenes, niobium pentoxides, tin alloys, titanium dioxide, tin dioxide, and mixtures of said substances.

The cathode (b) of the battery according to the invention preferably comprises a compound of formula LiMPO₄, wherein M is at least one transition metal cation of the first row of the periodic table, wherein said transition metal cation preferably is selected from the group consisting of Mn, Fe, Ni, and Ti or a combination of these elements, and wherein the compound preferably has an olivine structure, preferably an olivine superstructure, wherein Fe is particularly preferred.

A lithium iron phosphate having an olivine structure of the elemental formula LiFePO₄ may be used for the lithium-ion battery according to the invention. However, it is also possible to use a lithium iron phosphate, which contains an element M selected from the group consisting of Mn, Cr, Co, Cu, Ni, V, Mo, Ti, Zn, Al, Ga, B, and Nb. Further, it is also possible that the lithium iron phosphate contains carbon for increasing conductivity.

In a further embodiment, the lithium iron phosphate having olivine structure, which is used for the manufacture of the positive electrode, has the elemental formula LiₓFe_{1-y}M_{y}PO₄, wherein M is at least one element selected from the group consisting of Mn, Cr, Co, Cu, Ni, V, Mo, Ti, Zn, Al, Ga, B, and Nb, wherein 0.05≦x≦1.2 and 0≦y≦0.8.

In one embodiment, x=1 and y=0.

The positive electrode preferably contains the lithium iron phosphate in the form of nanoparticles. The nanoparticles may have any form, i.e. they may be approximately spherical or may be elongated.

In one embodiment, the lithium iron phosphate has a particle size of less than 15 μm, measured as D₉₅ value. Preferably, the particle size is less than 10 μm.

In a further embodiment, the lithium iron phosphate has a particle size between 0.005 μm up to 10 μm measured as D₉₅ value.

In a further embodiment, the lithium iron phosphate has a particle size of less than 10 μm measured as D₉₅ value, wherein the D₅₀ value is 4 μm±2 μm and the D₁₀ value is less than 1.5 μm.

The specified values may be determined by measurement using static laser light diffusion (laser diffraction). The methods are known from the prior art.

According to a preferred embodiment, the cathode may also comprise a lithium manganate, preferably LiMn₂O₄ of the spinel type, a lithium cobaltate, preferably LiCoO₂, or a lithium nickelate, preferably LiNiO₂, or a mixture of two or three of these oxides, or a mixed lithium oxide, which comprises nickel, manganese, and cobalt (NMC).

In a preferred embodiment, the cathode comprises at least one active material made from a lithium nickel manganese cobalt mixed oxide (NMC), which is not in a spinel structure, in a mixture with a lithium manganese oxide (LMO), which has a spinel structure.

It is preferred that the active material comprises at least 30 mole-%, preferably at least 50 mole-% NMC and, at the same time, at least 10 mole-%, preferably at least 30 mole-% LMO, based on the total mole number of active material of the cathode, respectively (i.e. not based on the cathode taken as a whole, which, in addition to the active material, may also comprise conductivity additives, binders, stabilizers, etc.).

It is preferred that NMC and LMO together form at least 60 mole-% of the active material, further preferred at least 70 mole-%, further preferred at least 80 mole-%, further preferred at least 90 mole-%, based the total mole number of the active material of the cathode, respectively (i.e. not based on the cathode taken as a whole, which, in addition to the active material, may also comprise conductivity additives, binders, stabilizers, etc.).

In principle, there are no restrictions concerning the composition of the lithium nickel manganese cobalt mixed oxide, except that this oxide must contain besides lithium, at least 5 mole-%, respectively, further preferred at least 15 mole-%, respectively, further preferred at least 30 mole-%, respectively, of nickel, manganese and cobalt, based the total mole number of transition metals in the lithium nickel manganese cobalt mixed oxide, respectively. The lithium nickel manganese cobalt mixed oxide may be doped with any other metal, in particular with transition metals, as long as it is ensured that the above-mentioned minimum molar amounts of Ni, Mn and Co are present.

Therein, a lithium nickel manganese cobalt mixed oxide of the following composition is particularly preferred: Li[Co_{1/3}Mn_{1/3}Ni_{1/3}]O₂, wherein the amount of Li, Co, Mn, Ni, and O may vary by ±5%, respectively.

In the positive electrode (b), the used lithium iron phosphate, respectively the lithium oxide or the lithium oxides, as well as the materials, which are used for the negative electrode (a), generally are held together by means of a binder, which keeps these materials on the electrode. For example, polymer binders may be used. Preferably, as binders, polyvinylidene fluoride, polyethylene oxide, polyethylene, polypropylene, polytetrafluoroethylene, polyacrylate, ethylene-(propylene-dien-monomer)-copolymer (EPDM), and mixtures and copolymers thereof may be used.

The separator (c), which is used for the battery, must be permeable for lithium ions in order to ensure the ion transport for lithium ions between the positive and the negative electrode. On the other hand, the separator must be non-conducting for electrons.

The separator of the battery according to the invention comprises a fleece made from non-woven polymer fibers, also known as “non-woven fabric”, which are electrically non-conducting. The term “fleece” is synonymously used with terms such as “fabric” or “felt”. Instead of the term “non-woven”, also the term “not woven” may be used.

Preferably, the fleece is flexible and has a thickness of less than 30 μm. Methods for the manufacture of such fleeces are known from the prior art.

Preferably, the polymer fibers are selected from the group of polymers consisting of polyacrylnitrile, polyolefin, polyester, polyimide, polyetherimide, polysulfone, polyamide, polyether.

Suitable polyolefins are, for example, polyethylene, polypropylene, polytetrafluoroethylene, polyvinylidenfluoride.

Preferred polyesters preferably are polyethylene terephthalates.

In a preferred embodiment, the separator comprises a fleece, which is coated, on one side or on both sides, with an inorganic material. The term “coating” also includes that the ion-conducting inorganic material is not only present on one side or on both sides of the fleece, but also within the fleece. The material, which is used for the coating, preferably is at least one compound from the group of oxides, phosphates, sulfates, silicates, aluminosilicates of at least one of the elements zirconium, aluminum or lithium.

The ion-conducting inorganic material preferably is ion-conducting in a temperature range of from −40° C. to 200° C., i.e. is ion-conducting for lithium ions.

In a preferred embodiment, the ion-conducting material comprises or consists of zirconium oxide.

Furthermore, a separator may be used, which consists of an at least partially material permeable carrier, which is not or only poorly conducting for electrons.

This carrier is coated on at least one side with an inorganic material. An inorganic material is used as a carrier that is at least partially permeable in regard to materials, which is formed as a non-woven fabric. The organic material is formed of polymer fibers, preferably polymer fibers of polyethylene terephthalate (PET). The fleece is coated with an inorganic ion-conducting material, which, preferably, is ion-conducting in a temperature range of from −40° C. to 200° C. The inorganic ion-conducting material preferably comprises at least one compound from the group of oxides, phosphates, sulfates, titanates, silicates, aluminosilicates, with at least one of the elements zirconium, aluminum, lithium, particularly preferred zirconium oxide. Preferably, the inorganic ion-conducting material comprises particles having a largest diameter of less than 100 nm.

Such a separator, for example, is commercialized in Germany by the company Evonik AG under the trademark “Separion®”.

Methods for the manufacture of such separators are known from the prior art, for example from EP 1 017 476 B1, WO 2004/021477 and WO 2004/021499.

In principle, pores that are too large and holes in the separators, which are used in secondary batteries, may result in an internal short circuit. The battery may itself discharge very rapidly in a dangerous reaction. Here, electric currents may occur that are high enough to result, in the worst case, in the explosion of the sealed battery cell. Due to this, the separator crucially contributes to safety, respectively, lack of safety of a lithium high performance or lithium high energy battery.

In general, polymer separators suppress any current transport through the electrolyte beyond a certain temperature (the so-called “shut-down temperature”, which is approximately 120° C.). This is effected since, at this temperature, the pore structure of the separator breaks down, and all pores are sealed. Since no ions may be transported any longer, the dangerous reaction, which may result in an explosion, stops. However, if the cell is further heated due to external circumstances, then, at approximately 150° C. to 180° C., the so-called “break-down temperature” is exceeded. The separator melts at this temperature, whereby it contracts. Now, both electrodes contact each other directly at many locations of the battery cell, and thus an extensive internal short circuit occurs. This results in an uncontrolled reaction that may result in an explosion of the cell, respectively the developed pressure must be reduced by means of a pressure control valve (a blow-out disc), frequently accompanied by fire.

However, such a shut-down (shut-off) may only occur in case of the preferred separator in the battery according to the invention, comprising a fleece of non-woven fabric and the inorganic coating, if, by means of high temperature, the polymer structure of the carrier material melts and penetrates into the pores of the inorganic material, thereby sealing said pores. However, such a break-down does not occur with this separator, since the inorganic particles ensure that a complete melting of the separator cannot occur. Thereby the separator ensures that there are no operations in which an extensive short-circuit may be generated.

By means of the type of the fleece used, which is a particularly well-suited combination of thickness and porosity, separators may be produced, which comply with the requirements of separators in high performance batteries, in particular in lithium high performance batteries. By means of the simultaneous use of oxide particles, which are precisely adjusted with respect to their particle size, for the manufacture of the porous (ceramic) coating, a particularly high porosity of the completed separator is achieved, whereby the pores are still sufficiently small in order to prevent an undesired protrusion of “lithium whiskers” through the separator.

Due to the high porosity of the separator, however, it must be ensured that there is no dead space in the pores.

According to the invention, the complete or at least nearly complete filling of the pores of the separator is achieved by means of the presence of the surfactant (e).

The separators, which are used for the invention also have the advantage that the anions of the conducting salt are partially attached to the inorganic surfaces of the separator material, which results in an improvement of the dissociation and thus in a better ion-conductivity in the high current range.

The separator, which is used for the battery according to the invention, comprising a flexible fleece comprising a porous coating on and within this fleece, wherein the material of the fleece is selected from non-woven, not electrically conducting polymer fibers, is also characterized in that the fleece has a thickness of less than 30 μm, a porosity of more than 50%, preferably of from 50% to 97%, and a distribution of the pore radii, in which at least 50% of the pores have a pore radius of 75 μm to 150 μm.

Particularly preferred is that the separator comprises a fleece, which has a thickness of from 5 μm to 30 μm, preferably a thickness of from 10 μm to 20 μm. Particularly preferred is also a pore radii distribution in the fleece being as homogenously as possible as mentioned above. A still more homogeneous pore radii distribution in the fleece results in an optimized porosity of the separator in connection with optimally adapted oxide particles of a certain size.

The thickness of the substrate has a great influence on the properties of the separator since, on the one hand, the flexibility depends on the thickness of the substrate, however, so does the surface resistance of the separator, which is impregnated with the electrolyte. Due to the low thickness, an electric resistance of the separator is achieved, which is particularly low for the use in combination with an electrolyte. The separator itself has an electric resistance, which is very high, since the separator itself must have non-conducting properties. Furthermore, thinner separators allow for an increased package density within a battery stack such that within the same volume a higher energy amount may be stored.

Preferably, the fleece has a porosity of from 60% to 90%, particularly preferred of from 70% to 90%. Therein, the porosity is defined as the volume of the fleece (100%) minus the volume of the fibers of the fleece, i.e. the proportion of the volume of the fleece, which is not filled by material. Therein, the volume of the fleece may be calculated from the dimensions of the fleece. The volume of the fibers results from the measured weight of the fleece and from the density of the polymer fibers. The high porosity of the substrate also allows for a higher porosity of the separator, for which reason the separator achieves a higher take-up of electrolyte.

In order to obtain a separator having non-conducting properties, said separator preferably comprises, as polymer fibers for the fleece, electrically non-conducting fibers of polymers as defined above, which preferably are selected from polyacrynitrile (PAN), polyester such as polyethyleneterephthalate (PET) and/or polyolefin (PO) such as polypropylene (PP) or polyethylene (PE), or mixtures of such polyolefines.

The polymer fibers of the fleeces preferably have diameter of from 0.1 μm to 10 μm, particularly preferred of from 1 μm to 4 μm.

Particularly preferred flexible fleeces have a surface weight of less than 20 g/m², preferably of from 5 g/m² to 10 g/m².

The separator comprises, on and in the fleece, a porous, electrically insulating, ceramic coating. Preferably, the porous inorganic coating, which is on and in the fleece, comprises oxide particles of the elements Li, Al, Si, and/or Zr having an average particle size of from 0.5 μm to 7 μm, preferably of from 1 μm to 5 μm, and particularly preferred of from 1.5 μm to 3 μm. Particularly preferred is that the separator comprises a porous inorganic coating, which is on and in the fleece, which comprises aluminum oxide particles having an average particle size of from 0.5 μm to 7 μm, preferably of from 1 μm to 5 μm, and particularly preferred of from 1.5 to 3 μm, which are adhesively bonded together by means of an oxide of the elements Zr or Si. In order to achieve a porosity that is as high as possible, preferably more than 50 wt-% and particularly preferred more than 80 wt-% of all particles comply with the above-mentioned limitation in regard to the average particle size. As already described above, the maximum particle size is from ⅓ to ⅕ and particularly preferred less or equal to 1/10 of the thickness of the used fleece.

Preferably, the separator has a porosity of from 30% to 80%, preferably of from 40% to 75%, and particularly preferred of from 45% to 70%. The porosity thereby relates to the accessible, i.e. to open pores. The porosity thereby may be determined by means of the known method of mercury porosimetry, or may be calculated from the volume and the density of the materials as used, assuming that only open pores are present.

The separators, which are used for the battery according to the invention, are also characterized in that they may have a tensile strength of at least 1 N/cm, preferably at least 3 N/cm and particularly preferred of from 3 N/cm to 10 N/cm. The separators preferably may be bent, without damage, to any radius down to 100 mm, preferably down to 50 mm and particularly preferred down to 1 mm.

The high tensile strength and the good bending property of the separator have the advantage that changes of the geometry of the electrodes, which occur during charging and discharging of the battery, may be tolerated by the separator without resulting in damage thereof. Furthermore, the bending property has the additional advantage that, with such separator, commercially standardized wound cells may be produced. In these cells, the electrode/separator layers are wound with each other in a standardized size in a spiral-shaped manner and are contacted.

Electrolytes (d) for lithium-ion batteries comprise a plurality of lithium salts. Preferred lithium salts comprise inert anions and are non-toxic. Suitable lithium salts preferably are lithium hexafluorophosphate, lithium hexafluoroarsenate, lithium bis(trifluoromethlysulfonylimide), lithium trifluoromethanesulfonate, lithium tris(trifluoromethylsulfonylimide)methide, lithium tetrafluoroborate, lithium perchlorate, lithium tetrachloroaluminate, lithium chloride, and mixtures thereof.

In one embodiment, the lithium salt is selected from LiPF₆, LiBF₄, LiClO₄, LiAsF₆, LiCF₃SO₃, LiN(CF₃SO₃)₂, LiC(CF₃SO₂)₃, LiSO₃CₓF₂ₓ₊₁, LiN(SO₂CₓF₂ₓ₊₁)₂ or LiC(SO₂CₓF₂ₓ₊₁)₃, wherein 0≦x≦8, and mixtures of two or more of these salts.

Preferably, the electrolyte is present as electrolyte solution. Suitable solvents preferably are inert. Preferred solvents, for example, comprise ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-diethoxymethane, tetrahydrofuran, 2-methyltetrahydrofuran, 1,3-dioxolane, methylacetate, ethylacetate, nitromethane, 1,3-propane sultone, and mixtures of two or more of said solvents.

The term “surfactant” in component (e) encompasses a substance which, by means of at least one hydrophilic and at least one hydrophobic structural moiety, may decrease the surface tension between a solid surface and a liquid. In consequence, the liquid remains at least partially attached to the solid surface without running off or rolling off said surface.

Such surfactants, which also frequently are termed as “wetting agent” in the technical literature, are known from the prior art.

In one embodiment, the surfactant (e) used in the battery according to the invention is selected from carboxylic acid esters and carboxylic acid amides, sulfonic acid esters and sulfonic acid amides, alkyl polyethylene glycols and alkyl polyethylene ethers, polyalkylene glycol ethers.

Carboxylic acid esters and carboxylic acid amides preferably are fatty acid esters and fatty acid amides, preferably fatty acid polyglycol ethers and fatty acid amide polyglycol ethers.

Sulfonic acid ethers and sulfonic acid amides preferably are alkyl sulfonic acid esters and amides and/or aryl sulfonic acid esters and amides. Exemplarily mentioned are benzene sulfonic acid esters and benzene sulfonic acid amides, dodecyl benzene sulfonic acid esters and amides, benzene sulfonic acid dodecyl esters.

Alkyl polyethylene glycols preferably are alkylphenol polyglycol ethers (alkylphenol ethoxylate).

As an example of a polyalkylene glycol ether, polyoxyethylene-2-stearyl ether is mentioned.

Examples of the mentioned surfactants (e) are commercially available. They are merely examples of surfactants, however, do not limit the surfactant (e) to the ones mentioned in the examples.

Preferably, the surfactant contains fluorine.

It is particularly preferred that the surfactant comprises a perfluorated alkyl group.

The term “perfluorated alkyl group” means that all hydrogen atoms of an alkyl group are replaced by fluorine atoms.

Fluorine-containing, respectively perfluorated alkyl groups-containing surfactants in general are inert under the operating conditions of the battery and/or do not generate by-products, which may negatively affect the operation of the battery.

Furthermore, in general, such substances may in a particularly efficient manner wet the electrodes and the separator of the battery according to the invention. This facilitates the filling of the pores, which are contained in the electrodes and in the separator, with electrolyte.

Exemplarily suitable compounds are the known compounds, or compounds produced according to known methods, which are perfluorooctane carboxylic acid esters and perfluorooctane sulfonic acid esters. Further mentioned are perfluoroalkylethylene glycols as disclosed in EP 0 571 717. Compounds comprising a sulfonic group such as disclosed in U.S. Pat. No. 6,960,410 are likewise mentioned. Also suitable are fluoroaliphatic esters such as the fluoroaliphatic esters that are known under the trademark Novec® such as Novec® FC-4430.

The above-mentioned compounds are merely examples of a fluorine-containing surfactant, however, do not limit the fluorine-containing surfactant to the mentioned compounds.

The use of fluorine-containing lithium salts in electrolyte (d) may synergistically support the effect of the surfactant (e), in particular when these salts also comprise perfluoroalkyl groups.

In one embodiment, the surfactant is used in an amount of from 0.001 to 10 wt-% of surfactant based on the total amount of electrolyte, preferably of from 0.05 to 5 wt-%, in particular preferred of from 0.1 to 1 wt-%.

It has been surprisingly discovered that, when formatting the battery, the use of the surfactant (e) in the filling of the battery with electrolyte, significantly lowers the irreversible capacity loss compared to a filling in which the surfactant (e) is not used. This is extraordinarily beneficial for a battery in which the capacity in the charge/discharge operation, i.e. in the application for the operation of, for example, an electric motor, has to be maintained as high as possible.

The term “formatting” or “formatting the battery” encompasses the first electrical charging in order to change the active masses in the electrodes to a “charged” condition.

The irreversible capacity loss may be determined by a method in which the capacity after the first charge and after the first discharge, respectively the second charge and the second discharge, is determined.

Accordingly, in one embodiment of the lithium-ion battery according to the invention, the surfactant preferably is selected such that the irreversible capacity loss in the formatting of the battery is lower than the irreversible capacity loss of the battery, when the battery is formatted in absence of the surfactant.

Already small improvements in said capacity behavior, for example by 1% to 5%, are considered as significant improvements.

Preferably, the surfactant is selected such that the irreversible capacity loss is 95% of the irreversible capacity loss of the battery at the most, when said battery is formatted in absence of the surfactant, preferably 90% at the most, particularly preferred 85% at the most.

The combination of the negative electrode (a) and the positive electrode (b) with, in particular, the separator (c) and the electrolyte (d) and the surfactant (e) results in a lithium-ion battery, which, besides a lowering of the irreversible capacity loss in the formatting of the battery as well as in the charge/discharge operation, also provides for an advantageous lowering of the increase of the alternating current internal resistance after the formatting, a lowering of the increase of the internal resistance vis-à-vis direct current voltage after the storage of the battery as well as a lowering of the increase of the irreversible capacity loss after storage of the battery.

Accordingly, the lithium-ion battery according to the invention is also characterized in that the internal resistance vis-à-vis alternating current, when formatting the battery, is lower than the internal resistance vis-à-vis alternating current of the battery, when said battery is formatted in absence of the surfactant; and/or the irreversible capacity loss of the battery after storage of the battery is lower than the irreversible capacity loss of the battery, when said battery is stored in absence of the surfactant; and/or the internal resistance vis-àvis direct current voltage after storage of the battery is lower than the internal resistance vis-à-vis direct current voltage, when said battery is stored without surfactant.

In principle, the manufacture of the lithium-ion battery according to the invention may be performed according to the methods known in the prior art.

For example, for the manufacture of the positive electrode, the used active material, e.g. the lithium iron phosphate, may be deposited in powder form on the electrode and may be compacted to a thin film, as the case may be, using a binder. The other electrode may be laminated on the first electrode, wherein the separator in the form of a foil is laminated on the negative or positive electrode prior to the lamination of the two electrodes. It is also possible to process the positive electrode, the separator and the negative electrode simultaneously by means of concurrent lamination. The composite made from electrodes and separator is then enclosed in a housing. The electrode may be filled into the battery as described in the prior art background section.

In a particular embodiment, the method for the manufacture of the lithium-ion battery according to the invention comprises steps (i) and (ii):
(i) inserting surfactant (e) into the battery comprising the components (a) to (c);
(ii) inserting electrolyte (d) into the battery.

Generally, it is possible to perform step (i) simultaneously with step (ii). Preferably, then, the surfactant is mixed with the electrolyte, further preferably dissolved in the electrolyte.

However, it is also possible to perform step (i) prior to step (ii), or to perform step (i) after step (ii). Preferably, then, the surfactant is dissolved in a non-aqueous solvent as it is also used in the electrolyte.

Preferably, the insertion of the electrolyte into the battery according to step (ii) may be accelerated compared to a method, which is performed without the use of the surfactant.

Accordingly, it is also possible with the battery according to the invention, to insert electrolyte into the battery according to step (ii) in an accelerated manner.

The combination of improved properties is extraordinarily beneficial for the use of the lithium-ion battery according to the invention in the charge/discharge operation as driving power for mobile information devices, for tools, electrically driven cars and for cars having a hybrid drive.

### EXAMPLES

A 40 Ah lithium battery was filled with an electrolyte. This electrolyte contained 0.5 wt-% of a surfactant (Novec® FC-4430 of company 3M) based on the electrolyte. Novec® FC-4430 contains fluoroaliphatic polymeric esters (B) according to the pertinent material safety data sheet.

For comparison, an identical battery was filled with the same electrolyte, which, however, did not contain Novec® FC-4430 (A).

The formatting capacities of both batteries are compared in the following table:

| | First | First | Irreversible | Second | AC |
|---|---|---|---|---|---|
| | Charge | Discharge | Capacity | Discharge | Resistance |
| | Capacity | Capacity | Loss | Capacity | at 1 kHz |
| | [Ah] | [Ah] | [%] | [Ah] | [mΩ] |
| A | 48.24 | 37.54 | 22.2 | 38.59 | 0.57 |
| B | 48.99 | 40.28 | 17.8 | 40.62 | 0.53 |

Concerning the discharge capacity, directly after the formatting cycle as well as in the second discharge process, a comparatively significantly higher capacity and thus a lowered capacity reduction of the battery could be observed, when the electrolyte contained the surfactant.

The internal resistance vis-à-vis alternating current AC was lower in the battery containing Novec® FC-4430.

Surprisingly, the battery containing Novec® FC-4430 had a better storage stability, when it was stored at higher temperature, approximately at 60° C.

In this case, the capacity loss of the battery containing the surfactant was significantly lower after a storage time for eight weeks at 60° C. compared to the battery without surfactant.

Advantageously, also the internal resistance vis-à-vis direct current voltage of the battery, which contained the surfactant, was lower compared to the battery, which did not contain a surfactant.

The respective values are compared with each other in the following table (average values of the results, which have been performed at two batteries, respectively):

| | | | DC | DC |
|---|---|---|---|---|
| | Irreversible | Irreversible | Internal | Internal |
| | Capacity Loss | Capacity Loss | Resistance after | Resistance after |
| | after five | after ten weeks | five weeks | ten weeks storage |
| | weeks storage | storage | storage | at 60° C. |
| | at 60° C. [%] | at 60° C. [%] | at 60° C. [mΩ] | [mΩ] |
| A | 43.17 | 57.87 | 5.08 | 6.64 |
| B | 24.70 | 41.08 | 3.10 | 3.95 |

The results show that, when filling relatively large format batteries with electrolyte, problems may arise relating to the impregnation of the pores of the electrodes and of the separator in the case of filling in absence of the surfactant.

1-14. (canceled)

15. A lithium-ion battery, comprising:
an anode;
a cathode;
a separator;
an electrolyte, comprising a lithium salt and a non-aqueous solvent; and
at least one non-ionic surfactant,
wherein the separator comprises a non-woven fabric that is coated on one or both side or sides with an inorganic material.

16. The lithium-ion battery according to claim 15, wherein the coating is a material which is at least one compound from the group of: oxides, phosphates, sulfates, titanates, silicates, aluminosilicates of at least one of the elements Zr, Al, or Li.

17. The lithium-ion battery according to claim 15, wherein the lithium salt is selected from the group of: LiPF₆, LiBF₄, LiC1O₄, LiAsF₆, LiCF₃SO₃, LiN(CF₃SO₂)₂, LiC(CF₃SO₂)₃, LiSO₃CₓF₂ₓ₊₁, LiN(SO₂F₂ₓ₊₁)₂ or LiC(SO₂CₓF₂ₓ₊₁)₃, with 0≦x≦8, and mixtures of two or more of these salts.

18. The lithium-ion battery according to claim 15, wherein the non-aqueous solvent is selected from: ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methylacetate, ethylacetate, nitromethane, 1,3-propane sultone, and mixtures of two or more of these solvents.

19. The lithium-ion battery according to claim 15, wherein the surfactant is a carboxylic acid ester, a carboxylic acid amide, a sulfonic acid ester, a sulfonic acid amide, an alkyl polyethylene glycol, or a polyalkylene glycol ether.

20. The lithium-ion battery according to claim 15, wherein the surfactant contains fluorine.

21. The lithium-ion battery according to claim 15, wherein the surfactant includes a perfluoroalkyl group.

22. The lithium-ion battery according to claim 15, wherein of from 0.001 wt-% to 10 wt-% of surfactant based on the total amount of electrolyte is used.

23. A method, comprising:
using the a lithium-ion battery according to claim 15 to lower irreversible capacity loss, when formatting the battery, wherein the surfactant is selected such that the irreversible capacity loss, when formatting the battery, is lower than the irreversible capacity loss of the battery when the battery is formatted in absence of said surfactant.

24. The method according to claim 23, wherein the irreversible capacity loss is 95% of the irreversible capacity loss of the battery at the most, when said battery is formatted in absence of the surfactant.

25. The method according to claim 23, wherein at least one of (a) the internal resistance vis-à-vis alternating current, when formatting the battery, is lower than the internal resistance vis-à-vis alternating current of the battery when said battery is formatted in absence of said surfactant, (b) the irreversible capacity loss of the battery is lower after storage of the battery than the irreversible capacity loss of the battery, when said battery is stored in absence of said surfactant, and (c) the internal resistance vis-à-vis direct current voltage after storage of the battery is lower than the internal resistance vis-à-vis direct current voltage, when said battery is stored in absence of said surfactant.

26. A method of manufacturing the lithium-ion battery as of claim 15, comprising:
(i) inserting surfactant (e) into the battery comprising components (a) to (c);
(ii) inserting electrolyte (d) into the battery.

27. The method according to claim 26, wherein
step (i) is simultaneously performed to step (ii); or
step (i) is performed prior to step (ii); or
step (i) is performed after step (ii).

28. A method comprising:
using the lithium-ion battery according to claim 15 in the charge/discharge operation to provide driving power for at least one of (a) mobile information devices, (b) tools, (c) electrically driven cars and (d) cars having hybrid drive.
